(19) United States
(12) Patent Application Publication
(10) Pub. No.: US 2025/0172191 A1
(43) Pub. Date: May 29, 2025

(54) VIBRATION DAMPER FOR A MOTOR VEHICLE

(71) Applicants: thyssenkrupp Bilstein GmbH, Ennepetal (DE); thyssenkrupp AG, Essen (DE)

(72) Inventor: Juergen SCHNEIDER, Iserlohn (DE)

(73) Assignees: thyssenkrupp Bilstein GmbH, Ennepetal (DE); thyssenkrupp AG, Essen (DE)

(21) Appl. No.: 18/955,612

(22) Filed: Nov. 21, 2024

(30) Foreign Application Priority Data
Nov. 24, 2023 (DE) 10 2023 132 901.4

(51) Int. Cl. F16F 9/504; F16F 9/19; F16F 9/32; F16F 9/34

(52) U.S. Cl. CPC F16F 9/504; F16F 9/19; F16F 9/3214; F16F 9/34; F16F 2222/12; F16F 2228/08; F16F 2230/42

(57) ABSTRACT

A vibration damper for a motor vehicle comprises a damper tube and a working piston which is arranged axially movably within the damper tube and divides the interior space of the damper tube into a working space on the piston rod side and a working space remote from the piston rod, wherein the working piston comprises a main piston, a first additional piston and a second additional piston, wherein the additional pistons each comprise an additional valve device, and wherein the additional pistons are connected fluidically to one another via a flow channel.

### CROSS REFERENCE TO RELATED APPLICATION

This application is a U.S. Non-Provisional that claims priority to German Patent Application No. DE 10 2023 132 901.4, filed Nov. 24, 2023, the entire content of which is incorporated herein by reference.

### FIELD

The present disclosure relates to a vibration damper for a motor vehicle with a frequency-sensitive damping system.

### BACKGROUND

Vibration dampers with a frequency-sensitive damping system are known, for example, from DE 10 2016 208 845 A1. Known vibration dampers with a frequency-sensitive damping system are usually provided on one side, for the rebound stage or the compression stage. A separate and, in particular, independent design of the compression and the rebound stage for different frequency ranges of the vibration damper excitation would be desirable. Furthermore, known vibration dampers with a frequency-sensitive damping system have a slow damping force adjustment in low speed ranges or damping force ranges of the vibration damper.

Thus a need exists to provide a vibration damper with a frequency-sensitive damping system which operates in the rebound and/or the compression stage independently of one another and enables a frequency-sensitive damping force adjustment even in a low speed or damping force range.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a diagrammatic illustration of a vibration damper in a longitudinal sectional view in accordance with one exemplary embodiment.

FIG. 2 shows a diagrammatic illustration of a detail of a vibration damper in a longitudinal sectional view in accordance with a further exemplary embodiment.

FIG. 3 shows a diagrammatic illustration of a detail of a vibration damper in a longitudinal sectional view in accordance with a further exemplary embodiment.

FIG. 4 shows a diagrammatic illustration of a detail of a vibration damper without a main piston valve in a longitudinal sectional view in accordance with a further exemplary embodiment.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

A vibration damper for a motor vehicle comprises, in accordance with a first aspect: a damper tube and a working piston which is arranged axially movably within the damper tube and divides the interior space of the damper tube into a working space on the piston rod side and a working space remote from the piston rod, wherein the working piston comprises a main piston and at least or exactly two additional pistons. The additional pistons each comprise an additional valve device, wherein the additional pistons are connected fluidically to one another via a flow channel, with the result that hydraulic fluid can flow from an additional piston through the flow channel to the other additional piston.

The working piston preferably comprises a first additional piston which is arranged in the working space on the piston rod side and a second additional piston which is arranged in the working space remote from the piston rod. The additional valve device of the first additional piston is preferably connected via the flow channel to the second additional piston, wherein the additional valve device of the second additional piston is preferably connected via the flow channel to the first additional piston. The working spaces of the vibration damper are therefore connected to one another fluidically via the flow channel and the two additional pistons. The flow channel can be flowed through by hydraulic fluid, in particular, in the rebound and in the compression stage of the vibration damper.

A working piston with a main piston and two additional pistons which are arranged in different working spaces enables additional damping, taking place via the additional valves of the additional pistons, of the hydraulic fluid both in the rebound and in the compression stage. Furthermore, damping which can be set independently of one another for the rebound and the compression stage is achieved by way of the separate arrangement of the two additional pistons.

The vibration damper is, for example, a monotube vibration damper or a multitube vibration damper. For example, a multitube vibration damper for a vehicle comprises an outer tube and an inner tube which is arranged coaxially with respect to the former, wherein an equalization space for receiving hydraulic fluid is configured between the outer tube and the inner tube, and a working piston which is connected to a piston rod and is arranged within the inner tube such that it can be moved to and fro, wherein the interior space of the inner tube is divided by way of the working piston into a first working space on the piston rod side and a second working space remote from the piston rod. The equalization space is preferably filled with a gas at least partially, in particular at the upper end. The outer tube preferably at least partially configures the housing of the vibration damper. The inner surface of the inner tube is preferably configured as a guide of the working piston. The working piston preferably comprises a valve device, by way of which the first and the second working space are connected to one another. No outer tube is preferably provided in the case of a monotube vibration damper. The inner tube is called a damper tube and, as described above in relation to the inner tube, receives the piston rod and the working piston.

In the case of a multitube vibration damper or monotube vibration damper, the vibration damper comprises, in particular, a closure package which is configured and arranged to fluidically seal the interior space of the outer tube on the piston rod side. The end of the inner tube on the piston rod side is preferably fastened to the closure package. Opposite the closure package, at the end remote from the piston rod, the equalization space and the second working space are preferably connected fluidically by means of a bottom valve. The equalization space is preferably connected fluidically to the first or second working space via openings in the inner tube. For example, the equalization space is connected to the inner tube via the bottom valve.

In the case of a monotube vibration damper, the vibration damper comprises, in particular, a closure package which is configured and arranged to fluidically seal the interior space of the damper tube on the piston rod side. The end of the damper tube on the piston rod side is preferably fastened to the closure package. Opposite the closure package, at the end remote from the piston rod, the interior space of the damper tube is preferably sealed fluidically by means of an axially movable sealing element. The sealing element preferably separates a gas space which adjoins it in the axial direction from the working space which is filled with hydraulic fluid.

In the following description, the term vibration damper is to be understood to mean both a multitube vibration damper and a monotube vibration damper, wherein the damper tube is the inner tube of a multitube vibration damper.

For example, a flow channel which fluidically connects the additional valve devices of the respective additional pistons to one another is configured in the piston rod. The working space which is remote from the piston rod and the working space on the piston rod side are preferably connected fluidically to one another via the flow channel and the additional valve devices. The flow channel is configured, in particular, substantially as an annular space and extends in the axial direction through the piston rod. The flow channel preferably comprises a plurality of flow passages for conducting the hydraulic fluid into the respective additional piston, in particular the respective additional valve device. For example, the flow channel has in each case one flow passage into each additional piston, in particular each additional valve device.

The flow channel extends, in particular, between the working space remote from the piston rod and the working space on the piston rod side to the at least one additional piston. If the vibration damper comprises two additional pistons, the flow channel preferably extends from the first additional piston, in particular from the first additional valve device, to the second additional piston, in particular the second additional valve device. The flow channel is preferably arranged hydraulically in parallel with the main piston, in particular a main valve device or a flow channel through the main piston.

Each additional valve device preferably comprises a fluid inlet for the inlet of hydraulic fluid into the respective additional piston, in particular the respective additional valve device, wherein each fluid inlet is optionally assigned a check valve, with the result that the fluid inlet can be flowed through exclusively in one flow direction. The check valve is preferably arranged in such a way that it completely closes the fluid inlet and preferably comprises at least one spring washer which preferably completely covers the respective fluid inlet. Each fluid inlet can preferably be flowed through exclusively in the flow direction from the respective working space inwards into the respective additional valve device. For example, the check valve of the fluid inlet is configured by way of the additional valve disc assembly.

Each additional valve device preferably comprises a fluid outlet for the outlet of hydraulic fluid from the respective additional valve device. Each fluid outlet is preferably assigned at least one outlet spring washer which is arranged as a check valve, with the result that the fluid outlet can be flowed through exclusively in one flow direction.

The vibration damper comprises, for example, an external damping valve device for damping the piston rod movement in the rebound stage and/or in the compression stage. The damping valve device is preferably attached outside the working piston, the inner tube and the outer tube.

In accordance with a first embodiment, the main piston comprises a main valve device and/or a main flow channel, and the flow channel is arranged hydraulically parallel to the main valve device and/or the main flow channel. As a result, a damping action in addition to the main valve device of the main piston is achieved by way of the additional pistons and the additional valve devices.

The working piston preferably comprises a main piston which bears at least partially against the damper tube in a fluid-tight manner, and at least one or two additional pistons. The main piston is preferably arranged between the additional pistons. For example, the additional piston does not have any flow passages and/or valve devices, and cannot be flowed through by hydraulic fluid or can be flowed through by hydraulic fluid exclusively through the flow channel. The additional pistons are arranged, for example, spaced apart from the damper tube, with the result that a fluid flow is possible between the additional pistons and the inner wall of the damper tube. The additional pistons are preferably attached to the piston rod coaxially with respect to the main piston, preferably in a positionally fixed manner. For example, one of the additional pistons, the first additional piston, is arranged within the working space on the piston rod side and in the rebound direction relative to the main piston. The other additional piston, the second additional piston, is arranged, for example, within the working space remote from the piston rod and in the compression direction relative to the main piston. The main piston is preferably arranged between the two additional pistons. The main piston and the at least one or the two additional pistons each preferably have a respective valve device.

The main valve device preferably connects the working space on the piston rod side to the working space remote from the piston rod. The main valve device preferably comprises a main valve body and at least two main flow channels which are configured in the main valve body, a first main flow channel and a second main flow channel. The main flow channels preferably extend in each case from an end side of the working piston, in particular of the main valve body, to the opposite end side, and are arranged separately with respect to one another, preferably fluidically separated from one another.

The main valve device preferably comprises at least two spring washer valves which are each attached to the end sides of the main valve device, in particular of the valve body. The spring washer valves are arranged, in particular, in such a way that they determine the flow passage of in each case only one main flow channel. Each main flow channel is preferably assigned precisely one spring washer valve. The main valve device preferably comprises a first spring washer valve which interacts with the first main flow channel in such a way that it determines the flow passage of the hydraulic fluid through the main flow channel, preferably in a manner which is dependent on the flow speed.

Each spring washer valve preferably comprises at least one spring washer assembly. The spring washer assemblies are preferably each preloaded against a main valve seat which is configured in the main valve body, and bear against the latter. The spring washer assemblies are preferably arranged on the respective main valve seat in such a way that they lift off from the main valve seat exclusively in the case of a throughflow of the respective main flow channel in one direction, and completely or partially release the flow cross section of the main flow channel.

By way of example, a sealing element, in particular a scaling ring, which preferably bears in a fluid-tight manner against the inner wall of the damper tube is attached in the circumferential direction around the main valve seat.

In accordance with a further embodiment, the flow channel comprises a flow passage which opens into the first additional piston for the inlet of hydraulic fluid, wherein the flow channel comprises a further flow passage which opens into the second additional piston for the inlet of hydraulic fluid. The flow passages are arranged within the piston rod, for example, and preferably enable a fluid connection of the flow channel to the additional pistons.

In accordance with a further embodiment, each additional valve device each comprises a fluid inlet for the inlet of hydraulic fluid into the additional valve device, wherein each additional piston comprises a fluid outlet for the outlet of hydraulic fluid from the additional piston, and wherein the fluid inlet of the first additional valve device of the first additional piston is connected fluidically via the flow channel to the fluid outlet of the second additional piston. The hydraulic fluid preferably flows into the two additional pistons and, in particular, exclusively through one additional piston valve. The additional piston valves are preferably arranged in such a way that they can each be flowed through exclusively in one flow direction, preferably exclusively in the rebound or the compression stage. Each fluid outlet interacts, for example, with an outlet spring washer assembly. The outlet spring washer assembly is preferably arranged in such a way that it completely closes the fluid outlet and preferably comprises at least one spring washer which preferably completely covers the respective fluid outlet. Each fluid outlet can preferably be flowed through, preferably exclusively in the flow direction from the interior of the respective additional valve device outwards into the respective working space, wherein the outlet spring washer assembly is preferably configured as a check valve.

In accordance with a further embodiment, the additional valve devices each comprise an additional valve body and an additional valve piston which is movable axially relative to the former, and an additional valve disc assembly which interacts with the additional valve piston, wherein the additional valve device comprises a preloading system for loading the additional valve disc assembly with a preloading force, and wherein the preloading system comprises at least one pressure chamber which has a variable volume. The pressure chamber with a variable volume in the preloading system enables frequency-dependent setting of the preload of the additional valve disc assembly and therefore frequency-dependent damping.

The volume of the pressure chamber can preferably be increased or decreased, in particular in a manner which is dependent on the hydraulic pressure which prevails in the pressure chamber. The pressure chamber is preferably arranged in such a way that it loads the additional valve piston with an axial force, in particular in the case of the pressure chamber being loaded with hydraulic pressure. The pressure chamber is arranged and configured, in particular, in such a way that a change in its volume results in a movement of the additional valve piston in the axial direction. The additional valve piston preferably bears directly or indirectly at least against the pressure chamber. The additional valve device comprises the preloading system for loading the additional valve piston with an axial force. The preloading system is preferably part of the respective additional piston and the respective additional valve device.

The additional valve device preferably has an additional valve body which is preferably attached to the piston rod in a positionally fixed manner. In particular, an axially movable additional valve piston is arranged within the additional valve body. The additional valve piston preferably bears at least partially against the additional valve body, and is attached such that it can be moved relative to the latter and to the piston rod in the axial direction. A sealing element is preferably arranged between the additional valve piston and the additional valve body for fluidic sealing with respect to one another. The additional valve body is preferably of pot-shaped configuration and is open in the axial direction of the outlet spring washer assembly. The additional valve piston is preferably received within the pot-shaped additional valve body in such a way that it slides in the axial direction on the piston rod and the additional valve body. The additional valve body preferably configures the housing of the additional valve device, in particular of the additional piston. In particular, the additional valve body is hollow-cylindrical with a cover region which points in the direction of the main piston, a hollow-cylindrical side region and a bottom region which points away from the main piston. The additional valve piston preferably comprises the additional valve seat and bears by way of the latter against the additional valve disc assembly. The additional valve device also comprises an additional valve disc assembly which interacts with the additional valve piston. In particular, the additional valve disc assembly bears directly or indirectly against the additional valve piston.

The additional valve disc assembly is preferably attached such that it can be moved axially relative to the additional valve body and/or the piston rod, with the result that it preferably moves axially together with the additional piston. It is likewise conceivable that the additional valve disc assembly is attached fixedly to the additional valve body and/or the piston rod. The additional valve piston is, for example, of single-part or multiple-part configuration. In particular, the additional valve disc assembly bears directly or indirectly against the additional valve piston. The additional valve disc assembly bears, for example, on an additional valve seat which is configured, for example, on the additional valve piston or the additional valve housing.

In accordance with a further embodiment, the preloading system comprises an orifice for the inlet of hydraulic fluid into the pressure chamber. The orifice is preferably configured as an opening, in particular in the piston rod or the additional valve body. The orifice, in particular the cross-sectional area of the orifice, enables filling of the pressure chamber with hydraulic pressure at a predefined speed in a manner which is dependent on the hydraulic pressure or the flow speed. As a result, a targeted damping force adjustment is achieved in a manner which is dependent on the excitation frequency of the vibration damper.

In accordance with a further embodiment, the preloading system comprises a first pressure chamber and a second pressure chamber. The volume of the first and/or the second pressure chamber can preferably be increased or decreased, in particular in a manner which is dependent on the hydraulic pressure which prevails in the respective pressure chamber. The first and/or the second pressure chamber are/is preferably arranged in such a way that they/it load/loads the additional valve piston with an axial force, in particular in the case of loading of the respective pressure chamber with hydraulic pressure. The first pressure chamber and/or the second pressure chamber are/is, in particular, arranged and configured in such a way that a change in their/its volume results in a movement of the additional valve piston in the axial direction. The additional valve piston preferably bears directly or indirectly at least against one pressure chamber, with the result that preferably at least one side surface of the additional valve piston delimits the pressure chamber. In particular, the second pressure chamber bears directly against the additional valve piston. The pressure chambers are preferably arranged separately with respect to one another. The additional valve disc assembly can preferably be loaded with a preloading force via the additional valve piston, with the result that the additional valve disc assembly is preloaded against the corresponding additional valve seat.

A preloading system with two or more pressure chambers each with a variable volume has the technical effect that the respective volumes of the pressure chambers change at a different speed in the case of excitation with different frequencies, and therefore bring about frequency-sensitive preloading of the additional valve disc assembly.

In accordance with a further embodiment, the first pressure chamber and a second pressure chamber are connected hydraulically in series with respect to one another. The pressure chambers are preferably arranged in such a way that they interact with the additional valve piston, with the result that the additional valve piston is moved axially in the case of a pressure change in the pressure chambers. The pressure chambers preferably bear against that side of the additional valve piston which lies opposite the additional valve disc assembly. In particular, the hydraulic active surface area of the additional piston is greater on the side which faces the pressure chambers than on the side which faces the additional valve disc assembly. If the same pressure prevails on the additional valve piston on both sides, in particular on the pressure chamber and the fluid inlet into the additional valve device, the additional valve piston is preferably deflected in the direction of the additional valve disc assembly, in particular in the preloading direction.

In a load case, the second pressure chamber is preferably arranged downstream of the first pressure chamber, and bears, in particular, directly against the additional valve piston. The pressure chambers have, in particular, different volumes. The first pressure chamber preferably has a smaller volume than the second pressure chamber. The connection in series of the pressure chambers with, in particular, different volumes ensures a stepped speed profile of the movement of the additional piston, wherein, due to the connection in series, the second pressure chamber brings about a displacement of the additional piston only when the first pressure chamber is filled.

The first pressure chamber is arranged, for example, in such a way that the additional valve piston can be moved over a first axial travel range by means of the force which results from the hydraulic pressure of the first pressure chamber, and wherein the second pressure chamber is arranged in such a way that the additional valve piston can be moved over a second axial travel range by means of the force which results from the hydraulic pressure of the second pressure chamber. The first axial travel range is a part, in particular a portion, of the second axial travel range. The second axial travel range is preferably the maximum axial deflection, in particular the complete axial movement range of the additional piston. The different volumes in the different pressure chambers advantageously bring about different axial movements of the additional piston, with the result that the axial deflection of the piston is different for low and high speed ranges of the movement of the working piston.

In accordance with a further embodiment, the preloading system comprises a first orifice for the inlet of hydraulic fluid into the first pressure chamber and a second orifice for the inlet of hydraulic fluid into the second pressure chamber. The second orifice is preferably arranged between the first and the second pressure chamber. The first and the second pressure chamber are connected, for example, directly to one another via the second orifice. The first and the second orifice are preferably each configured as an inlet, in particular as an inlet opening, for the inlet of hydraulic fluid into the respective pressure chamber. The fluid inlet for the inlet of hydraulic fluid into the preloading system is preferably covered by a spring washer which configures a check valve. In particular, the first orifice is configured as an opening in the spring washer. Filling the pressure chambers via respectively associated orifices affords the advantage of separate filling, for example at different filling speeds, of the respective pressure chambers. The first orifice is optionally configured as a flow opening in the flow channel, wherein, in particular, exclusively one additional piston is provided.

In accordance with a further embodiment, the first orifice has a greater cross-sectional area than the second orifice. For example, the cross-sectional area of the first orifice has approximately from 2 to 10 times, preferably from 3 to 6 times, in particular 5 times the cross-sectional area of the second orifice. The two orifices optionally have the same size. For example, the first orifice is configured as a main flow channel in the main piston or as a cross-sectional constriction in the main flow channel of the main piston. For example, the main piston does not comprise a main valve device. The orifices have, for example, different cross-sectional areas. This ensures different filling speeds of the two pressure chambers. A larger first orifice brings about more rapid filling of the first pressure chamber, which results in a more rapid volume change of the first pressure chamber, and therefore the additional piston is also moved at a higher speed during filling of the first pressure chamber than in the case of filling of the second pressure chamber.

In accordance with a further embodiment, the preloading system comprises a separating washer which separates the first pressure chamber and the second pressure chamber fluidically from one another. The separating washer is, for example, a separating spring washer.

In accordance with a further embodiment, the second orifice is configured as an opening in the separating washer, in particular the separating spring washer, for the fluidic connection of the first and the second pressure chamber. The first and the second pressure chamber are preferably connected fluidically to one another exclusively via the second orifice. As a result, a connection in series of the two pressure chambers and preferably filling of the pressure chambers at different speeds are enabled.

The second pressure chamber is preferably configured between the additional valve piston and the separating spring washer, wherein the first pressure chamber is configured between the separating spring washer and the additional valve body or the main piston. The separating spring washer and the additional valve disc assembly are preferably arranged on opposite sides of the additional valve piston.

For example, the first and/or second orifice which are/is configured as an opening are/is of circular or slot-shaped configuration. In particular, the separating spring washer has a plurality of openings which are preferably arranged at the same radial spacing from the piston rod and together configure the second orifice.

In accordance with a further embodiment, the separating washer is attached axially movably relative to the additional valve body and the piston rod. In accordance with a further embodiment, the separating spring washer bears against the additional valve piston and can preferably be moved with the latter. The axial movability of the separating spring washer enables a volume change of the first pressure chamber in the case of a movement of the separating spring washer, in particular together with the additional valve piston, and therefore enables simple coupling of the volume change of the first pressure chamber to the movement of the additional piston.

In accordance with a further embodiment, the preloading system comprises an axial stop for limiting the axial movement of the separating spring washer. The stop is preferably configured in the additional valve body and configures, in particular, a bearing surface for the separating spring washer. The bearing surface is, in particular, spaced apart from the bottom region. The side region of the additional valve body preferably comprises an inner wall which is configured as an axial sliding surface of the additional valve piston and along which the additional valve piston can slide. A cut-out is preferably configured in the inner wall, which cut-out extends axially in the direction of the additional valve piston from the end which points in the direction of the bottom region and opens in the bearing surface. The stop, in particular the bearing surface, extends in a preferably radial direction and preferably configures an axial stop for the spring washer. The stop is preferably configured and arranged in such a way that it limits the axial movement of the separating spring washer and therefore the volume increase of the first pressure chamber.

For example, the additional valve disc assembly is fastened to the valve body. In particular, the additional valve disc assembly is attached in a positionally fixed manner relative to the piston rod and cannot be moved relative to the latter. It is likewise conceivable that the additional valve disc assembly is fastened to the additional valve piston.

In particular, the additional valve piston has a recess which at least partially configures the second pressure chamber. The recess preferably increases the hydraulic active surface area of that side surface of the additional valve piston which faces the second pressure chamber.

In accordance with a further embodiment, the separating washer bears against the additional valve piston and can be moved, for example, with the latter. It is likewise conceivable that the separating washer is attached in a positionally fixed manner in the additional valve device. As a result, merely the volume of one pressure chamber, namely of the second pressure chamber, is variable.

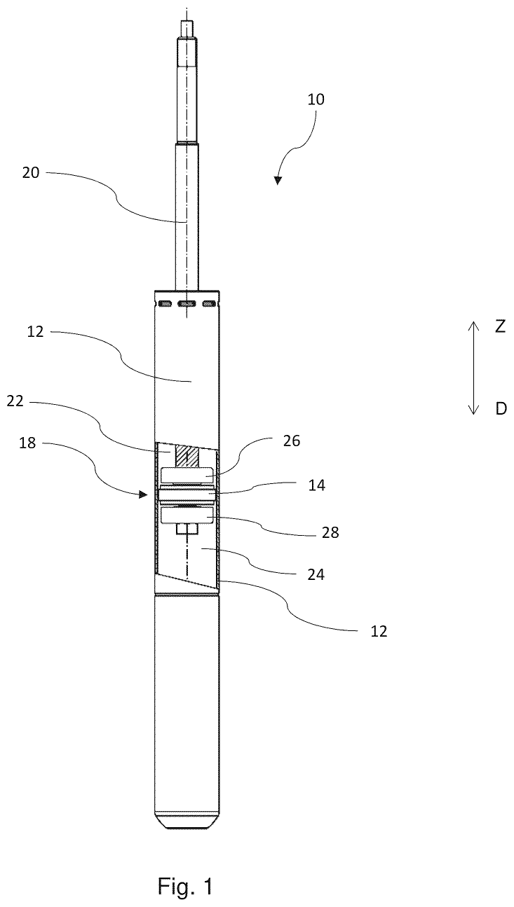

FIG. 1 shows a vibration damper 10, wherein the vibration damper 10 is a monotube vibration damper. It is likewise conceivable that the vibration damper is a multitube vibration damper, for example a 2-tube vibration damper. The vibration damper 10 has a damper tube 12 which, in the case of the monotube vibration damper which is shown in FIG. 1, forms the outer tube and configures an outer surface, in particular a housing, of the vibration damper 10.

A working piston 18 which is connected to a piston rod 20 is arranged within the damper tube 12 in such a way that it can be moved within the damper tube 12, wherein the damper tube 12 is preferably configured as a guide of the working piston 18. The working piston 18 comprises, for example, a valve device (not shown in FIG. 1). The working piston 18 divides the interior space of the damper tube 12 into a first working space 22 which is arranged on the piston rod side and a second working space 24 which is arranged remote from the piston rod.

The interior space of the damper tube 12 is sealed fluidically on the piston rod side, for example, by means of a closure package. Lying opposite the closure package, at the end remote from the piston rod, the interior space of the damper tube 12 is sealed, for example, by means of a separating piston fluidically with respect to an adjoining gas space. The gas space is arranged within the damper tube 12, and the separating piston is preferably attached axially movably within the damper tube 12.

It is likewise conceivable that the vibration damper is configured as a multitube vibration damper. In the case of a vibration damper which is configured as a multitube vibration damper, an outer tube is arranged around the damper tube 12 and coaxially with respect to the latter. An equalization space which is preferably filled at least partially with a hydraulic fluid is configured between the outer tube and the inner tube. For example, the equalization space is filled partially with a gas. Lying opposite the closure package, at the end remote from the piston rod, the interior space of the damper tube 12 of the multitube vibration damper is preferably sealed fluidically by means of a bottom piece. A bottom valve which, in particular, is arranged at the end of the inner tube remote from the piston rod is arranged by way of example on the bottom piece. The second working space 24 is preferably connected fluidically to the equalization space via the bottom valve.

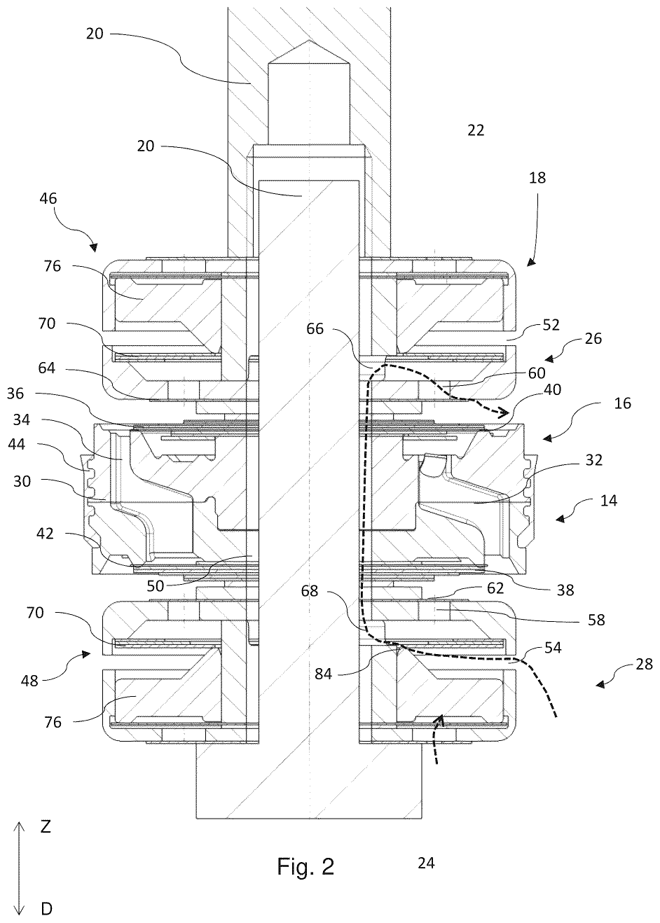

The working piston 18 comprises a main piston 14 which bears at least partially against the damper tube 12 in a fluid-tight manner. Furthermore, the working piston 18 comprises two additional pistons 26, 28, a first additional piston 26 and a second additional piston 28. It is likewise conceivable that the working piston has merely one additional piston. FIGS. 1 and 2 show a vibration damper with two additional pistons merely by way of example. The additional pistons 26, 28 are arranged spaced apart from the damper tube 12 by way of example, with the result that a fluid flow is possible between the additional pistons 26, 28 and the inner wall of the damper tube 12. The additional pistons 26, 28 are preferably attached in a positionally fixed manner to the piston rod 20, in particular coaxially with respect to the main piston 14. By way of example, the first additional piston 26 is arranged within the working space on the piston rod side 22 and in the rebound direction Z relative to the main piston 26. By way of example, the second additional piston 28 is arranged within the working space remote from the piston rod 24 and in the compression direction D relative to the main piston 26. The main piston 14 and the additional pistons 26, 28 each preferably have a respective valve device. The main piston 14 comprises by way of example a main valve device 16, and the additional pistons 26, 28 each have an additional valve device 46, 48.

FIG. 2 shows a detailed view of the working piston 18 with the main piston 14 and the additional pistons 26, 28. The main piston 14 comprises a main valve device 16. The main valve device 16 connects the working space on the piston rod side 22 to the working space remote from the piston rod 24. The main valve device 16 comprises a main valve body 30 and at least two main flow channels 32, 34 which are configured in the main valve body 30, a first main flow channel 32 and a second main flow channel 34. The main flow channels 32, 34 preferably each extend from an end side of the working piston 18, in particular of the main valve body 30, to the opposite end side, and are separate from one another, preferably arranged fluidically separated from one another.

The main valve device 16 comprises at least two spring washer valves 36, 38 which are each attached to the end sides of the main valve device 16, in particular of the valve body 30. The spring washer valves 36, 38 are arranged in such a way that they define the flow passage of in each case only one main flow channel 32, 34. Each main flow channel 32, 34 is preferably assigned precisely one spring washer valve 36, 68. The main valve device 16 preferably comprises a first spring washer valve 36 which interacts with the first main flow channel 32 in such a way that it defines the flow passage of the hydraulic fluid through the main flow channel 32, preferably in a manner which is dependent on the flow speed.

Each spring washer valve 36, 38 preferably comprises at least one spring washer assembly. The spring washer assemblies each comprise a plurality of spring washers and are each preloaded against a main valve seat 40, 42 which is configured in the main valve body 30, and bear against this main valve seat. The spring washer assemblies are preferably arranged on the respective main valve seat 40, 42 in such a way that they lift off from the main valve seat 40, 42 exclusively in the case of a throughflow of the respective main flow channel 32, 34 in one direction and completely or partially release the flow cross section of the main flow channel 32, 34. The spring washer valves 36, 38 are preferably configured as check valves, with the result that the spring washer assembly does not lift off from the respective main valve seat 40, 42 in the case of a flow in the respectively other direction. The respective spring washer valve 36, 38 is situated in an open position when the spring washer assemblies of the respective spring washer valve 36, 38 are lifted off from the respective main valve seat 40, 42. When the spring washer assemblies bear against the respective main valve seat 40, 42, the respective spring washer valve 36, 38 is in a closed position.

In the case of a movement of the piston rod 20 in the compression direction D, the first main flow channel 32 is flowed through in the rebound direction Z, wherein the first spring washer valve 36 is opened in the case of a throughflow of this type. The first spring washer valve 36 is therefore also called a compression stage valve. In the case of a movement of the piston rod 20 in the rebound direction Z, the second main flow channel 34 is flowed through in the compression direction D, wherein the second spring washer valve 38 is opened in the case of a throughflow of this type. The second spring washer valve 38 is therefore also called a rebound stage valve. The spring stiffness of the spring washers, the number and the dimensions of the spring washers preferably here define the damping characteristics of the piston movement in the rebound or compression direction.

A sealing element 44 which preferably bears in a fluid-tight manner against the inner wall of the damper tube 12 is attached by way of example around the main valve seat 30 in the circumferential direction.

The additional pistons 26, 28 each have a respective additional valve device 46, 48 which are preferably of substantially identical configuration. The additional valve devices 46, 48 are preferably each arranged within the respective additional piston 26, 28. The piston rod 20 is by way of example of two-part configuration, wherein a single-part configuration is likewise conceivable. A flow channel 50 which connects the additional pistons 26, 28, in particular additional valve devices 46, 48, fluidically to one another is preferably configured in the piston rod 20. The working space on the piston rod side 22 and the working space remote from the piston rod 24 are preferably connected to one another via the flow channel 50 and the additional pistons 26, 28, in particular the additional valve devices 46, 48. The flow channel 50 is preferably configured as an annular space and extends in the axial direction through the piston rod 20. The flow channel 50 is configured, for example, within the piston rod 20 or between the piston rod 20 and the working piston 18 which is attached to it. The flow channel 50 preferably has a plurality of flow passages 66, 68 for conducting the hydraulic fluid into the respective additional piston 26, 28.

The flow channel 50 preferably extends in the flow direction of the hydraulic fluid from the first additional piston 26, in particular from the first additional valve device 46 to the second additional piston 28, in particular the second additional valve device 48. The flow channel 50 is preferably arranged hydraulically parallel to the main piston 14, in particular the main valve device 16.

Each additional valve device 46, 48 has a fluid inlet 52, 54 for the inlet of hydraulic fluid into the respective additional valve device 46, 48. Each additional piston 26, 28 has a fluid outlet 58, 60 for the outlet of hydraulic fluid from the respective additional piston 26, 28, in particular the respective additional valve device 46, 48. Each fluid outlet 58, 60 is preferably assigned an outlet spring washer 62, 64, with the result that the fluid outlet 58, 60 can be flowed through exclusively in one flow direction. The outlet spring washer 62, 64 preferably comprises at least one spring washer which preferably completely covers the respective fluid outlet 58, 60. Each fluid outlet 58, 60 can preferably be flowed through preferably exclusively in the flow direction from the interior of the respective additional piston 26, 28 outwards into the respective working space 22, 24, and is preferably configured as a check valve.

The flow channel 50 has by way of example at least or precisely two flow passages 66, 68. For example, each additional piston 26, 28 is connected fluidically to the flow channel 50 via in each case at least or precisely one flow passage 66, 68. By way of example, the fluid inlet 52, 54 of each additional valve device 46, 48 of an additional piston 26, 28 is each connected fluidically via a flow passage 66, 68 to the flow channel 50 and a fluid outlet 58, 60 of the respectively other additional piston 26, 28. For example, the fluid inlet 52 of the first additional valve device 46 of the first additional piston 26 is fluidically connected to the fluid outlet 58 of the second additional piston 28 via the flow channel 50. In particular, the fluid inlet 54 of the second additional valve device 48 of the second additional piston 28 is connected to the fluid outlet 60 of the first additional piston 26 via the flow channel 50.

The fluid flow is shown in FIG. 2 for a movement of the piston rod 20 in the compression direction D by way of the interrupted arrow. During operation of the vibration damper 10 and in the case of a movement of the working piston 18 in the compression direction D, the hydraulic fluid flows through the main piston 14 in the rebound direction Z and opens the first spring washer valve 36 if the hydraulic pressure exceeds the opening pressure of the first spring washer valve 36. Parallel to the flow into the main piston 14, the hydraulic fluid flows through the fluid inlet 54 of the second additional valve device 48 into the latter and subsequently opens the second additional valve device 48 if the opening pressure of the additional spring washer assembly 70 is exceeded. Via the flow passage 68, the hydraulic fluid subsequently flows into the flow channel 50 of the piston rod 20 and from the latter via the flow passage 66 into the first additional piston 26 to the fluid outlet 60 of the first additional piston 26 and, if the opening pressure of the outlet spring washer 64 is exceeded, leaves the first additional piston 26 into the working space on the piston rod side 22. In the case of a movement of the piston rod 20 in the rebound direction Z, the first additional valve device 46 and the main valve device 16 are correspondingly opened.

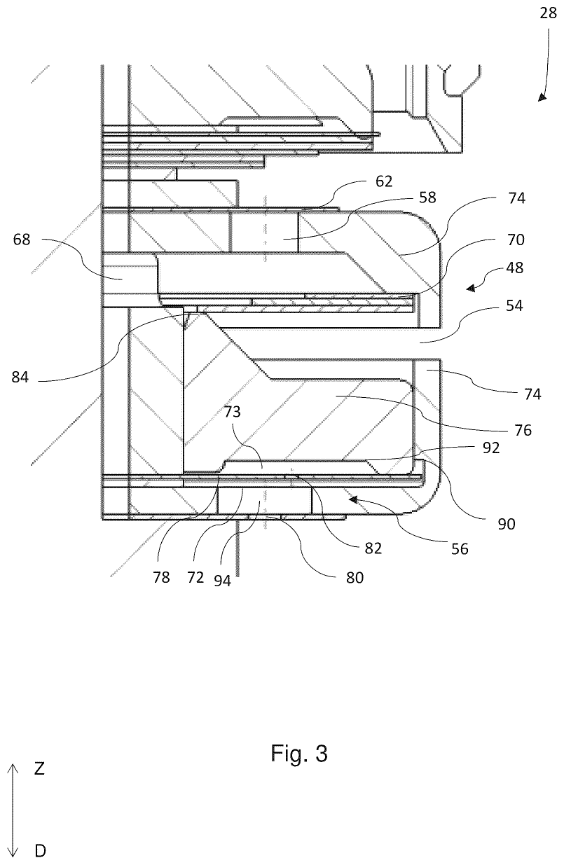

FIG. 3 shows a detailed illustration of a detail of the second additional valve device 48. The second additional valve device 48 is preferably of substantially identical configuration to the first additional valve device 46, for which reason only one of the two additional valve devices 46, 48 will be described by way of example in the following text. The additional valve device 46, 48 comprises by way of example an additional valve disc assembly 70 which each comprises at least one or a plurality of spring washers. The additional valve disc assembly 70 is preferably connected downstream of the fluid inlet 58, 60 of the additional valve device 46, 48 in the flow direction of the hydraulic fluid. In particular, the additional valve disc assembly 70 can be loaded with a preloading force. The additional valve disc assembly 70 preferably bears against an additional valve seat 84 in the closed position and is preloaded, in particular, against the latter with a preloading force. In the open position of the additional valve device 46, 48, the additional valve disc assembly 70 is lifted off from the additional valve seat 84.

The additional valve device 46, 48 comprises an additional valve body 74 which is preferably attached to the piston rod 20 in a positionally fixed manner. By way of example, the additional valve body 74 configures the housing of the additional valve device 46, 48, in particular of the additional piston 26, 28. In particular, the additional valve body 74 is hollow-cylindrical with a cover region which points in the direction of the main piston 14, a hollow-cylindrical side region and a bottom region which points away from the main piston 14. By way of example, an axially movable additional valve piston 76 is arranged within the additional valve body 74. The additional valve piston 76 preferably bears at least partially against the additional valve body 74 and is attached such that it can be moved relative to the latter and to the piston rod 20 in the axial direction.

The additional valve piston 76 preferably comprises the additional valve seat 84 and bears with the latter against the additional valve disc assembly 70. By way of example, the additional valve piston 76 has a diameter which decreases in the direction of the additional valve seat. A movement of the additional valve piston 76 in the axial direction brings about a change in the preload of the additional valve disc assembly 70 on the valve seat. The additional valve disc assembly 70 is by way of example fastened to the additional valve body 74, in particular is braced to the latter. The additional valve disc assembly 70 comprises by way of example three spring washers which bear against one another, wherein the lower spring washer which bears against the valve seat has the greatest diameter and the further spring washers have by way of example a smaller diameter.

The additional valve device 46, 48 preferably comprises a preloading system 56 for loading the additional valve disc assembly 70 with a preloading force, in particular for loading the additional valve piston 76 with an axial force. The preloading system 56 is preferably part of the additional piston 26, 28 and the additional valve device 46, 48. The preloading system 56 preferably comprises a first pressure chamber 72 and a second pressure chamber 73 which are connected hydraulically in series with one another. The pressure chambers 72, 73 are arranged in such a way that they interact with the additional valve piston 76, with the result that the additional valve piston 76 is moved axially in the case of a pressure change in the pressure chambers 72, 73.

The pressure chambers 72, 73 are preferably arranged on that side of the additional valve piston 76 which lies opposite the additional spring washer assembly 70. Furthermore, the preloading system 56 comprises by way of example two orifices 80, 82 which each serve as an inlet for the inlet of hydraulic fluid into a respective pressure chamber 72, 73. The first orifice 80 is preferably configured and arranged as an inlet for the inlet of hydraulic fluid into the first pressure chamber 72. The preloading system 56 has by way of example a fluid inlet 94 which is configured as a bore in the additional valve body 74 and is arranged, in particular, on that side of the additional valve body 74 which faces away from the main piston 14. The fluid inlet 74 is preferably covered by a spring washer 96 which configures a check valve and, in particular, permits exclusively a hydraulic flow from the additional piston 26, 28, in particular the preloading system 56, into the respective working space 22, 24. The first orifice 80 is configured by way of example as an opening in the spring washer.

The first and the second pressure chamber 72, 73 are separated from one another by way of example by way of a separating spring washer 78, with the result that the first pressure chamber 72 and the second pressure chamber 73 each bear against the spring washer 78. The second orifice 82 is preferably configured as an opening in the spring washer 78 and as an inlet of hydraulic fluid from the first pressure chamber 72 into the second pressure chamber 73. The separating spring washer 78 bears by way of example against the additional valve piston 76. In particular, the separating spring washer 78 is attached in an axially movable manner relative to the piston rod 20 and the additional valve body 74. The separating spring washer 78 can preferably be moved together with the additional valve piston 76. The first orifice 80 preferably has a greater cross-sectional area than the second orifice 82. The first pressure chamber 72 is configured by way of example between the separating spring washer 78 and the additional valve body 74, wherein the second pressure chamber 73 is preferably configured between the separating spring washer 78 and the additional valve piston 76.

Moreover, the preloading system 56 comprises by way of example an axial stop 90 for limiting the axial movement of the separating spring washer 78. The axial stop 90 is configured by way of example in the additional valve body 74. In particular, the stop 90 is configured as a radial stop surface for making contact with, in particular receiving, the separating spring washer 78. The stop 90 preferably limits the volume, in particular the volume increase, of the first pressure chamber 72.

The first and the second pressure chamber 72, 73 of the preloading system 56 of a respective additional piston 26, 28 are preferably connected fluidically exclusively to the working space 22, 24, in which the respective additional piston 26, 28 is arranged. The pressure chambers 72, 73 are not connected fluidically to the two working spaces 22, 24. The additional valve piston 76 has by way of example a recess 92 which at least partially configures the second pressure chamber 73. The separating spring washer 78 and the additional valve disc assembly 70 are preferably arranged on opposite sides of the additional valve piston 76.

During operation of the vibration damper 10 and in the case of an excitation of the piston rod 20 in the compression direction D at, for example, a low speed, first of all the first pressure chamber 72 is filled with hydraulic fluid which enters the first pressure chamber 72 through the first orifice 80. The hydraulic fluid flows out of the first pressure chamber 72 via the second orifice 82 into the second pressure chamber 73 which is likewise filled with hydraulic fluid. The second orifice 82 has a smaller cross section than the first orifice 80, with the result that the second pressure chamber 73 is filled more slowly with hydraulic fluid than the first pressure chamber 72. The rising hydraulic pressure in the first pressure chamber 72 brings about a movement of the separating spring washer 78 and the additional valve piston 76 which bears against it in the axial direction, wherein the volume of the first pressure chamber 72 increases. In the case of a volume increase of the first pressure chamber 72, the separating spring washer 78 is moved as far as the stop 90, wherein the separating spring washer 78 and the additional valve piston 76 are moved at a first speed here. After the stop 90 is reached and the separating spring washer 78 is in contact with it, a further volume increase of the first pressure chamber 72 is no longer possible. The pressure rise in the second pressure chamber 73 takes place more slowly as a result of the smaller orifice size of the second orifice 82 and therefore ensures a slower volume increase of the second pressure chamber 73 which results in an axial movement of the additional piston 76. In particular, after the separating spring washer 78 comes into contact with the stop 90, the additional piston 76 is moved at a second speed which is lower than the first speed. This ensures that, in particular in the case of slow piston speeds, frequency-sensitive setting of the preload of the additional valve disc assembly 70 takes place. High frequencies bring about a movement of the additional valve piston 76 at the first speed, wherein lower frequencies bring about a movement of the additional valve piston 76 first of all at the first speed and subsequently at the second speed, with the result that higher damping, in particular preloading of the additional valve disc assembly 70, takes place at lower frequencies.

During operation of the vibration damper and in the case of an excitation in the compression direction D, hydraulic fluid additionally flows through the fluid inlet 52, 54 to the additional valve device 46, 48 and opens the latter if the hydraulic pressure exceeds the opening pressure of the preferably preloaded additional valve disc assembly 70. The hydraulic fluid preferably flows through the additional valve device 46, 48 into the flow channel 50 to the fluid outlet 58, 60 of the opposite additional piston 26, 28 and into the opposite working space 22, 24, in particular the low-pressure space.

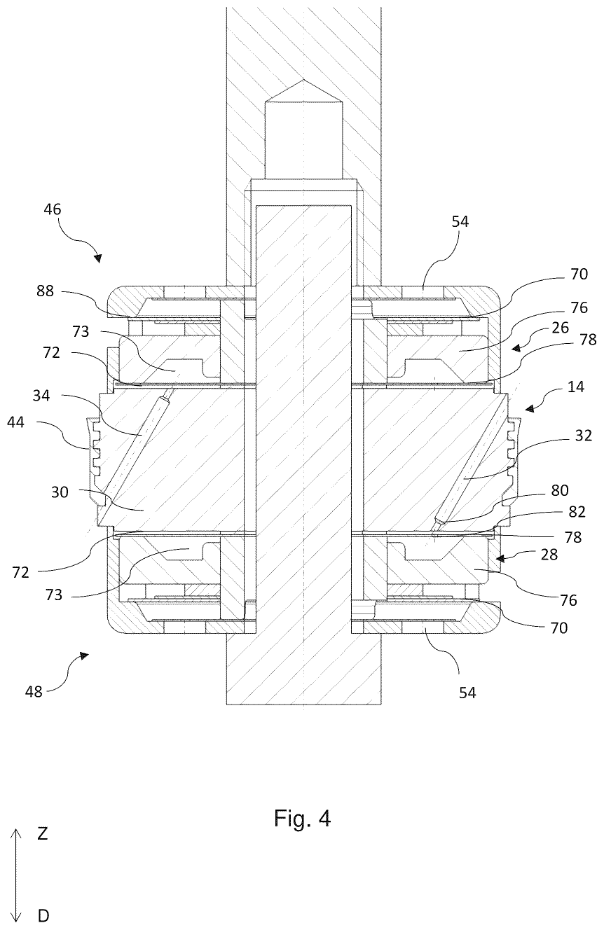

FIG. 4 shows a further exemplary embodiment which corresponds substantially to that of FIGS. 1 to 3, wherein, in contrast to FIGS. 1 to 3, the main piston 14 does not comprise a main valve device 16. The main piston 14 comprises merely the main flow channels 32, 34. The damping of the hydraulic flow preferably takes place exclusively by way of the additional valve devices 46, 48 which are connected to one another via the flow channel 50.

In the exemplary embodiment of FIG. 4, the additional valve piston 76 is by way of example of two-part configuration, wherein that region of the additional valve piston 76 which bears against the additional valve disc assembly 70 is configured by way of example as an annular disc. It is likewise conceivable that the additional valve piston comprises more than two parts which are together attached such that they can be moved relative to the additional valve housing 74. The additional valve seat 88 is configured by way of example in the additional valve housing 74, with the result that the additional valve disc assembly 70 bears against the valve seat 88 of the additional valve housing 74 in the closed position. The additional valve disc assembly 70 is attached by way of example in an axially movable manner, with the result that it preferably moves together with the additional valve piston.

The pressure chambers 72, 73 are arranged by way of example on that side of the respective additional piston 26, 28 which faces the main piston 14. The fluid inlet 54 for the inlet of hydraulic fluid into the additional valve device 46, 48 is arranged by way of example on that side of the additional piston 26, 28 which faces away from the main piston 14, and is covered, in particular, by a spring washer which is configured as a check valve. The check valve is arranged in such a way that a hydraulic flow from the additional piston 26, 28, in particular the additional valve device 46, 48 into the respective working space 22 is prevented.

The main flow channels 32, 34 configure by way of example the first orifice 80 which is configured as an inlet for the inlet of hydraulic fluid into the first pressure chamber 72. The main flow channels 34 preferably have a cross-sectional constriction which configures the first orifice 80.

During operation of the vibration damper 10 of FIG. 4, in particular in the case of a movement of the piston rod in the compression direction D, hydraulic fluid flows through the fluid inlet 54 into the second additional piston 48 and subsequently into the flow channel 50 to the first additional piston 26 into the first additional valve device 26. If the opening pressure of the additional valve disc assembly 70 of the first additional valve device 46 is exceeded, the latter is opened and the hydraulic fluid flows out into the low-pressure space. At the same time, hydraulic fluid flows through the second main flow channel 34 into the first pressure chamber 72 and subsequently into the second pressure chamber 73, wherein the preloading of the additional valve disc assembly 70 is set in the way which is described in relation to FIG. 3.

### LIST OF REFERENCE NUMERALS

10 Vibration damper
12 Damper tube
14 Main piston
16 Main valve device
18 Working piston
20 Piston rod
22 Working space on the piston rod side
24 Working space remote from the piston rod
26 First additional piston
28 Second additional piston
30 Main valve body
32 First main flow channel
34 Second main flow channel
36 First spring washer valve
38 Second spring washer valve
40 First main valve seat
42 Second main valve seat
44 Sealing element
46 First additional valve device
48 Second additional valve device
50 Flow channel
52, 54 Fluid inlet
56 Preloading system
58, 60 Fluid outlet
62, 64 Outlet spring washers
66, 68 Flow passage
70 Additional valve disc assembly
72 First pressure chamber
73 Second pressure chamber
74 Additional valve body
76 Additional valve piston
78 Separating spring washer
80 First orifice
82 Second orifice
84 Additional valve seat
86 Spacer washer
88 Valve seat
90 Stop
92 Recess
94 Fluid inlet
96 Spring washer

1. A vibration damper for a motor vehicle, comprising:
a damper tube, and
a working piston which is arranged axially movably within the damper tube and divides an interior space of the damper tube into a working space on a piston rod side and a working space remote from the piston rod,
wherein the working piston comprises a main piston, a first additional piston, and a second additional piston,
wherein the additional pistons each comprise an additional valve device, and wherein the additional pistons are connected fluidically to one another via a flow channel.

2. The vibration damper according to claim 1, wherein the main piston comprises a main valve device and/or a main flow channel, and the flow channel is arranged hydraulically parallel to the main valve device and/or the main flow channel.

3. The vibration damper according to claim 1, wherein the flow channel comprises a flow passage which opens into the first additional piston for the inlet of hydraulic fluid, and wherein the flow channel comprises a further flow passage which opens into the second additional piston for the inlet of hydraulic fluid.

4. The vibration damper according to claim 1, wherein each additional valve device each comprises a fluid inlet for the inlet of hydraulic fluid into the additional valve device, wherein each additional piston comprises a fluid outlet for the outlet of hydraulic fluid from the additional piston, and wherein the fluid inlet of the first additional valve device is connected fluidically by the flow channel to the fluid outlet of the second additional piston.

5. The vibration damper according to claim 1, the additional valve devices each comprise:
an additional valve body and an additional valve piston which is movable axially relative to the former, and
an additional valve disc assembly which interacts with the additional valve piston,
wherein the additional valve device comprises a preloading system for loading the additional valve disc assembly with a preloading force, and wherein the preloading system comprises at least one pressure chamber which has a variable volume.

6. The vibration damper according to claim 5, wherein the preloading system comprises an orifice for the inlet of hydraulic fluid into the pressure chamber.

7. The vibration damper according to claim 5, wherein the preloading system comprises a first pressure chamber and a second pressure chamber.

8. The vibration damper according to claim 7, wherein the first pressure chamber and a second pressure chamber are connected hydraulically in series with respect to one another.

9. The vibration damper according to claim 7, wherein the preloading system comprises a first orifice for the inlet of hydraulic fluid into the first pressure chamber and a second orifice for the inlet of hydraulic fluid into the second pressure chamber.

10. The vibration damper according to claim 9, wherein the first orifice has a greater cross-sectional area than the second orifice.

11. The vibration damper according to claim 7, wherein the preloading system comprises a separating washer which separates the first pressure chamber and the second pressure chamber.

12. The vibration damper according to claim 11, wherein the second orifice is configured as an opening in the separating washer for the fluidic connection of the first and the second pressure chamber.

13. The vibration damper according to claim 11, wherein the separating washer is attached axially movably relative to the additional valve body.

14. The vibration damper according to claim 13, wherein the preloading system comprises an axial stop for limiting the axial movement of the separating washer.

15. The vibration damper according to claim 11, wherein the separating washer bears against the additional valve piston.
